(19) United States
(12) Patent Application Publication
(10) Pub. No.: US 2021/0190606 A1
(43) Pub. Date: Jun. 24, 2021

(54) STRAIN GAGES AND METHODS FOR MANUFACTURING THEREOF

(71) Applicant: Vishay Measurements Group, Inc., Malvern, PA (US)

(72) Inventors: Thomas P. KIEFFER, Raleigh, NC (US); Eric K. WINCHESTER, Apex, NC (US)

(73) Assignee: Vishay Measurements Group, Inc., Malvern, PA (US)

(21) Appl. No.: 16/723,349

(22) Filed: Dec. 20, 2019

(51) Int. Cl. G01L 1/16; B32B 15/08; B32B 37/02; B32B 15/04; B32B 15/20

(52) U.S. Cl. CPC G01L 1/16; B32B 15/08; B32B 37/02; B32B 2255/20; B32B 15/20; B32B 2255/06; B32B 15/043

(57) ABSTRACT

A strain gage comprises: a flat metallic element; a first layer, wherein the flat metallic element is laminated onto a first surface of the first layer and the flat metallic element covers a first part of the first surface of the first layer; and a second layer laminated onto a second surface of the first layer, wherein the second surface is opposite to the first surface, and a coefficient of thermal expansion (CTE) of the second layer is greater than a threshold value.

### FIELD OF INVENTION

The present application relates generally to strain gages, and, more particularly to strain gages having a modified coefficient of thermal expansion.

### BACKGROUND

A strain gage can be attached to an object (e.g., a substrate) with an adhesive in order to measure a strain applied to the object. Most of the time, a strain gage and an object to which the strain gage will be attached are made from different materials. Therefore, the coefficient of thermal expansion (CTE) of the strain gage and the CTE of the object are not identical. In that case, a stress will be developed in the glue-line between the strain gage and the object if the environmental temperature changes. This is particularly relevant if the adhesive is a room temperature curing epoxy and strain measurement is performed at elevated temperature.

### SUMMARY

The present application discloses strain gages and methods for manufacturing the strain gages which substantially solve one or more existing technical problems due to limitations and disadvantages of the related art.

According to an embodiment of the present application, a strain gage comprises: a flat metallic element; a first layer, wherein the flat metallic element is laminated onto a first surface of the first layer and the flat metallic element covers a first part of the first surface of the first layer; and a second layer laminated onto a second surface of the first layer, wherein the second surface is opposite to the first surface, and a coefficient of thermal expansion (CTE) of the second layer is greater than a threshold value.

According to another embodiment of the present application, a method for manufacturing a strain gage comprises: preparing a flat metallic element and a first layer; laminating the flat metallic element onto a first surface of the first layer wherein the flat metallic element covers a first part of the first surface of the first layer; and preparing and laminating a second layer onto a second surface of the first layer, wherein the second surface is opposite to the first surface, and a coefficient of thermal expansion (CTE) of the second layer is greater than a threshold value.

### BRIEF DESCRIPTION OF THE DRAWING(S)

FIG. 1 illustrates a top cross-section view of a strain gage according to an embodiment of the present application;

FIG. 2 is a side view of the strain gage shown in FIG. 1;

FIG. 3 is a side cross-section view of the strain gage shown in FIG. 1 which has been installed onto an object;

FIG. 4 illustrates a scenario in which a thermal expansion of a strain gage according to an embodiment of this application is equal to a thermal expansion of an object onto which the strain gage has been installed;

FIG. 5 illustrates a scenario in which a thermal expansion of a strain gage according to an embodiment of this application is greater than a thermal expansion of an object onto which the strain gage has been installed;

FIG. 6 illustrates a scenario in which a thermal expansion of a strain gage according to an embodiment of this application is less than a thermal expansion of an object onto which the strain gage has been installed;

FIG. 7A is a schematic drawing illustrating a layer structure of the strain gage along dotted line I-I′ shown in FIG. 2;

FIG. 7B is another schematic drawing illustrating a layer structure of the strain gage along dotted line I-I′ shown in FIG. 2;

FIG. 7C is a side cross-section view of the strain gage along dotted line I-I′ shown in FIG. 2; and

FIG. 8 is a flow chart illustrating a method for manufacturing a strain gage according to an embodiment of this application.

### DETAILED DESCRIPTION OF THE PREFERRED EMBODIMENTS

In order to make those objects, technical solutions and advantages of the present application more apparent, some exemplary embodiments according to the present application will be described in detail below with reference to accompanying drawings. It should be noted that the described embodiments are only a part of the embodiments of the present application, and are not to be construed as to be limiting to the scope of this application. All other embodiments obtained by those skilled in the art based on the embodiments described herein without departing from the scope of the present application are intended to fall within the scope of this application. In the present description and the drawings, the same reference numerals will be used to represent substantially the same elements and functions, and the repetitive description of these elements and functions will be omitted. In addition, descriptions of elements, functions and configurations well known in the art may be omitted for clarity and conciseness.

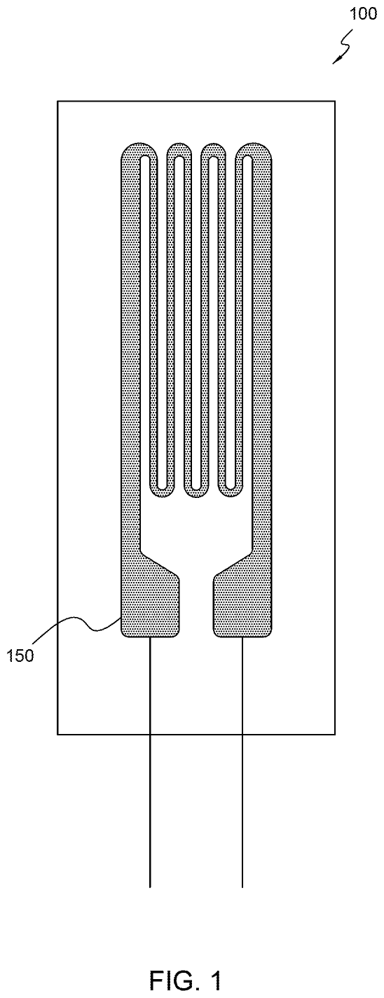

A strain gage 100 according to an embodiment of the present application will be described with reference to FIGS. 1-6 and FIGS. 7A-7C. It will be appreciated that a “strain gage” may also be referred to as a “strain gauge.”

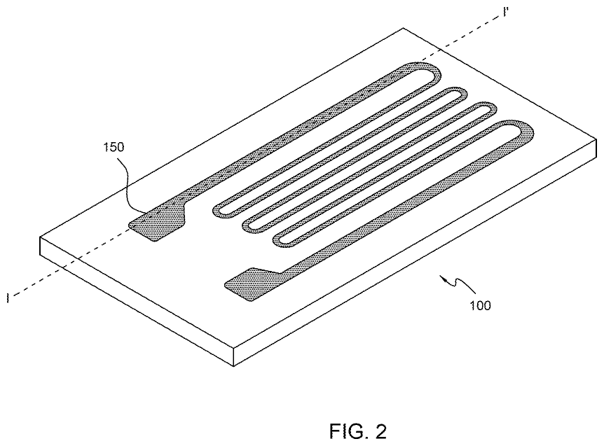

FIG. 1 is a top cross-section view of the strain gage 100. FIG. 2 is a side view of the strain gage 100 shown in FIG. 1. As shown in FIG. 1 and FIG. 2, the strain gage 100 may comprise a metallic element 150. The metallic element 150 may be formed within the strain gage 100 with a certain pattern (e.g., a serpentine pattern shown in FIG. 2). The metallic element 150 will be described in detail later.

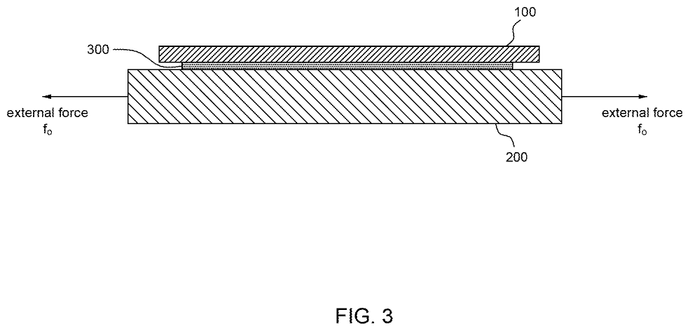

FIG. 3 is a side cross-section view of the strain gage 100 which has been installed onto a test object 200 through an adhesive 300 (also may be referred to as glue-line 300). As shown in FIG. 3, the strain gage 100 according to the present application can be installed onto a test object 200 through an adhesive 300 in order to measure an external force f₀ applied to the test object 200. The test object 200 may be any of a variety of materials, such as various metals (e.g. steel, stainless steel, aluminum, etc.), various ceramics (e.g. aluminum oxide, titanium silicate, silicon carbide, etc.), and various plastics (e.g. acrylic, polycarbonate, polyvinyl chloride, etc.). As such, the test object 200 may have a variety of temperature-expansion characteristics, i.e. coefficient of thermal expansion (CTE), depending upon the particular material selected.

A stress may be developed in the glue-line 300 between the strain gage 100 and the test object 200 because of changes in environmental temperature. For example, when the environmental temperature rises, the test object 200 expands in a horizontal direction shown in FIG. 3. Similarly, for the same rise in environmental temperature, the strain gage 100 expands in a horizontal direction. If the expansion of the test object 200 and the expansion of the strain gage 100 in response to rise in environmental temperature are not the same magnitude, then a stress will be developed in the glue-line 300.

It will be appreciated that the above examples of the test object 200 are not intended to be exclusive or be limiting to different scenarios where the strain gage 100 may be applied. In the following description, unless indicated otherwise, a metal substrate will be taken as an example of the test object 200.

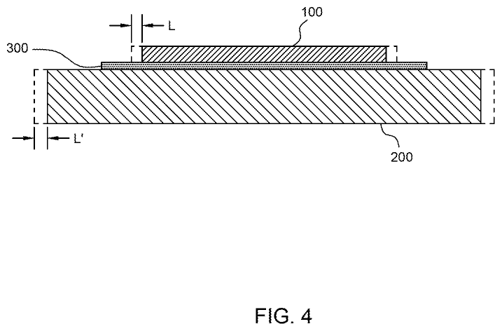

As briefly discussed above, a stress may exist in the glue-line between a strain gage and a test object. Different scenarios in which this kind of stress may exist will be illustrated with reference to FIGS. 4-6.

A strain gage and a test object may be manufactured from the same material, and thus their thermal expansions are the same. That is, the strain gage and the test object may have the same CTE.

For example, as shown in FIG. 4, a CTE of a strain gage 100 is the same as a CTE of a test object 200. Therefore, when the environmental temperature rises, the strain gage 100 and the test object 200 have the same thermal expansion (i.e., the same thermal expansion rate). That is, those dotted boxes at the left end of both the strain gage 100 and the test object 200 have the same length in horizontal direction (i.e., L=L′). Similarly, those dotted boxes at the right end of both the strain gage 100 and the test object 200 have the same length in horizontal direction. In this scenario, the glue-line stress is neutral.

In some scenarios, the strain gage 100 and the test object 200 shown in FIG. 4 may be manufactured from different materials, but they may still share the same or a similar CTE. For example, the strain gage 100 may be manufactured from multiple materials (e.g., metals and resins), and the strain gage 100 may have a CTE, as a whole, less than a CTE of resins and meanwhile greater than a CTE of metals. Similarly, the test object 200 may be a metal substrate manufactured from multiple metal alloys, and the test object 200 may have a CTE, as a whole, less than a CTE of some of the metal alloys and meanwhile greater than a CTE of other metal alloys.

It will be appreciated that the scenario shown in FIG. 4 may only happen in an ideal condition. Most of time, a strain gage and a test object do not share the same CTE, and thus the glue-line stress is not neutral. Typically, a strain gage may be manufactured from materials different from those used to manufacture a test object, and thus they may have different thermal expansions.

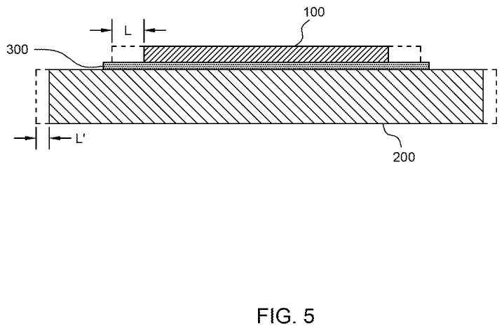

For example, as shown in FIG. 5, a CTE of a strain gage 100 is greater than a CTE of a test object 200. Therefore, when the environmental temperature rises, the strain gage 100 and the test object 200 have different thermal expansions (i.e., different thermal expansion rates). That is, the dotted box at the left end of the strain gage 100 has a length in horizontal direction greater than that of the dotted box at the left end of the test object 200 (i.e., L>L′). Similarly, the dotted box at the right end of the strain gage 100 has a length in a horizontal direction greater than that of the dotted box at the right end of the test object 200. In this scenario, the glue-line stress is in compression.

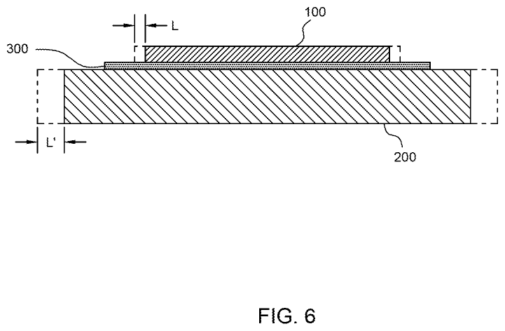

For another example, as shown in FIG. 6, a CTE of a strain gage 100 is less than a CTE of a test object 200. Therefore, when the environmental temperature rises, the strain gage 100 and the test object 200 have different thermal expansions (i.e., different thermal expansion rates). That is, the dotted box at the left end of the strain gage 100 has a length in horizontal direction less than that of the dotted box at the left end of the test object 200 (i.e., L<L′). Similarly, the dotted box at the right end of the strain gage 100 has a length in horizontal direction less than that of the dotted box at the right end of the test object 200. In this scenario, the glue-line stress is in tension.

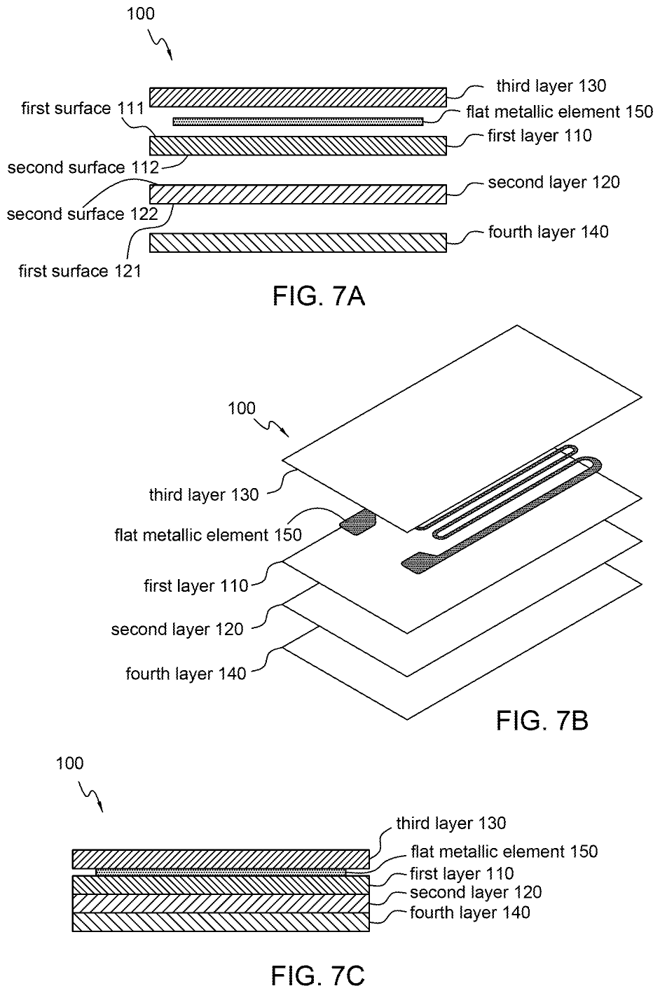

It should be noted that although the strain gage 100 and the test object 200 have different thermal expansions as shown in FIGS. 5-6, this difference may still be within a desired range at the temperature which strain measurements are made. That is, the CTE difference between the strain gage 100 and the test object 200 is not of sufficient magnitude over the temperature range of strain measurement to exceed the strength of the adhesive in the glue-line 300. The glue-line stress shown in FIGS. 5-6 will not exceed the strength of the adhesive as long as the CTE difference is within the desired range at the temperature which strain measurements are made. The strain gage according to the present application may be used to reduce the above-mentioned glue-line stress, thereby both preventing the glue-line adhesive from being damaged by the glue-line stress and thereby improving accuracy of its measurement. The description below with reference to FIGS. 7A-7C will describe how to maintain this difference within the desired range.

Preferably, the desired range of the CTE difference between the strain gage 100 and the test object 200 may be a range from approximately −3×10⁻⁶/° F. to approximately 3×10⁻⁶/° F. This is particularly true for a room temperature curing adhesive 300 used to attach a strain gage to a test object for strain measurement at elevated temperature of approximately 400° F. The lower end of the range (i.e., approximately −3×10⁻⁶/° F.) means that the CTE of the strain gage 100 is 3×10⁻⁶/° F. lower than the CTE of the test object 200. This lower end of the range approximately corresponds to the scenario shown in FIG. 6. The higher end of the range (i.e., approximately 3×10⁻⁶/° F.) means that the CTE of the strain gage 100 is 3×10⁻⁶/° F. higher than the CTE of the test object 200. This higher end approximately corresponds to the scenario shown in FIG. 5.

FIGS. 7A-7C illustrate the strain gage 100 according to an embodiment of this application.

FIG. 7A and FIG. 7B are schematic drawings illustrating a layer structure of the strain gage 100 along dotted line I-I′ shown in FIG. 2. It will be appreciated that the space between two different components shown in FIGS. 7A and 7B is only intended to show a layer structure of the strain gage 100 from a cross section perspective, and in the strain gage 100, those components are stacked together as shown in FIG. 7C. FIG. 7C is a side cross-section view of the strain gage 100 along dotted line I-I′ shown in FIG. 2.

As shown in FIGS. 7A-7C, the strain gage 100 comprises: a flat metallic element 150; a first layer 110, wherein the flat metallic element 150 is laminated onto a first surface 111 of the first layer 110 and the flat metallic element 150 covers a first part of the first surface 111 of the first layer 110; and a second layer 120 laminated onto a second surface 112 of the first layer 110, wherein the second surface 112 is opposite to the first surface 111, and a CTE of the second layer 120 is greater than a threshold value. The above-mentioned components of the strain gage 100 will be described in detail as follows.

The flat metallic element 150 may be a strain sensitive metallic element. The flat metallic element 150 is a crucial component which may be used to measure a strain corresponding to an external force applied to the strain gage 100.

When an external force (e.g., the external force f₀ shown in FIG. 3) is applied to an object 200, the object 200 will expand along a horizontal direction, thereby causing the strain gage 100 including the flat metallic element 150 to expand in a similar way. Thus, a strain may be caused to the flat metallic element 150. In other words, the external force f₀ may be transferred from the test object 200 to the flat metallic element 150. An electrical resistance of the flat metallic element 150 varies with an external force applied. Therefore, as the test object 200 is deformed by the external force f₀, the flat metallic element 150 is deformed accordingly, causing its electrical resistance to change. Thus, the flat metallic element 150 can be used to convert the external force f₀ into a change in electrical resistance which can then be measured. For example, by measuring the electrical resistance change through a particular circuit such as a Wheatstone bridge, a strain corresponding to the external force f₀ can be obtained.

In an embodiment, as shown in FIG. 2 and FIGS. 7A-7C, the flat metallic element 150 may be manufactured to be flat in a three-dimensional perspective. A flat strain sensitive metallic element may be helpful to decrease the thickness of the strain gage 100 thereby causing the strain gage 100 to be easier to be attached to the test object 200. Further, a flat metallic element may increase contact area between the strain gage 100 and the test object 200 thereby causing it to be more sensitive to a strain applied to the test object 200.

The term “flat” mentioned above means that a length of the metallic element 150 in a horizontal direction shown in FIG. 7A is greater than a thickness of the metallic element 150 in a vertical direction shown in FIG. 7A.

It will be appreciated that the dimension of the flat metallic element 150 shown in FIGS. 7A-7C is not intended to be limiting to a choice of its dimension. The relationship between a length and a thickness of the flat metallic element 150 may vary based on its application scenarios. For example, in an embodiment, a length of the flat metallic element 150 may be 200 times its thickness. In another embodiment, a length of the flat metallic element 150 may be 2500 times its thickness.

As shown in FIG. 2 and FIG. 7B, the flat metallic element 150 may be a metallic foil, i.e., the flat metallic element may have a flat metallic foil pattern in a horizontal direction. A flat metallic foil may increase the strain sensitivity and the measurement accuracy of the strain gage 100. Preferably, as shown in FIG. 7B, the metallic foil 150 has a serpentine pattern. That is, the metallic foil 150 may have a serpentine cross section view in a horizontal direction.

It will be appreciated that the metallic foil pattern of the flat metallic element 150 shown in FIG. 7B is not intended to be limiting to a choice of the flat metallic element 150. Any metallic foil pattern suitable to measure a strain applied to the test object 200 may be chosen. For example, the metallic foil may have other patterns available to obtain an electrical resistance change, such as a reticular pattern and a shutter pattern.

The flat metallic element 150 may be made from one or multiple alloys which are sensitive to a change of electrical resistance.

In an embodiment, the flat metallic element 150 may be made from one or multiple of nickel alloys. In that case, the flat metallic foil 150 may be made from at least one alloy from a group comprising copper-nickel, nickel-chromium, nickel-aluminum, etc. Preferably, the flat metallic foil 150 may be made from at least one of copper-nickel, nickel-chromium or nickel-aluminum.

In an embodiment, the flat metallic element 150 may also be made from one or multiple of iron alloys. In that case, the flat metallic element 150 may be made from at least one alloy from a group comprising iron-aluminum, iron-chromium-aluminum, etc. Preferably, the flat metallic foil 150 may be made from at least one of iron-aluminum or iron-chromium-aluminum.

In an embodiment, the metallic foil may also be made from one or multiple of platinum alloys. In that case, the flat metallic element 150 may be made from at least one alloy from a group comprising platinum-tungsten, platinum-chromium, etc. Preferably, the flat metallic foil 150 may be made from at least one of platinum-tungsten or platinum-chromium.

In an embodiment, the flat metallic element 150 may be made from any combination of multiple alloys mentioned above. For example, the flat metallic element 150 may be made from at least two from a group comprising copper-nickel, nickel-chromium, nickel-aluminum, iron-aluminum, iron-chromium-aluminum, iron-nickel-chromium, platinum-tungsten, platinum-chromium, etc. Preferably, the flat metallic foil 150 may be made from at least two of copper-nickel, nickel-chromium, nickel-aluminum, iron-aluminum, iron-chromium-aluminum, iron-nickel-chromium, platinum-tungsten or platinum-chromium.

Although the above-mentioned embodiments describe those alloy materials which may be used to manufacture the flat metallic element 150, it will be appreciated that they are only described as a way of example, and they are not intended to be exclusive or be limiting to the present application. For example, the flat metallic element 150 may also be made from one or multiple piezoelectric materials. Once an outside force is applied to the strain sensitive metallic element 150, there will be a piezoelectric effect caused by electrical charges' movements. Then, by measuring an electrical charge change, a strain corresponding to the outside force can be obtained.

In the following description, unless otherwise indicated, the above-mentioned metallic foil will be considered as an exemplary embodiment of the flat metallic element 150. Thus the flat metallic element 150 may also be referred to as the flat metallic foil 150.

A Coefficient of Thermal Expansion (CTE) of the flat metallic foil 150 may vary because of different materials used for manufacturing the flat metallic foil 150. In an embodiment, a CTE of the metallic foil 150 may have a range greater than or equal to approximately 5×10⁻⁶/° F. and less than or equal to 12×10⁻⁶ 1° F.

A thickness of the metallic foil 150 has a range greater than or equal to approximately 0.0001 inch and less than or equal to approximately 0.0005 inch. This range of its thickness is crucial. On the one hand, typically the metallic foil 150 may be thinner than the first layer 110 (described below), and typically the first layer 110, as a backing, should be thicker than 0.0005 inch in order to obtain enough strength to support other components. On the other hand, if a thickness of the metallic foil 150 is less than 0.0001 inch, it will become relatively fragile and thus cannot withstand a strain applied. It will be noted that a thickness of the flat metallic foil 150 may be determined based on a thickness of the first layer 110 and an overall thickness of the strain gage 100. The thickness parameters of the first layer 110 and the strain gage 100 will be specifically described below.

The metallic foil 150 may be laminated onto the first surface 111 of the first layer 110 and the metallic foil 150 covers a first part of the first surface 111 of the first layer 110.

As shown in FIG. 7A, the first surface 111 is the top surface of the first layer 110. However, a layer sequence shown in FIG. 7A is only illustrated as an example of the strain gage 100. It will be appreciated that the first surface of the first layer 110 may be either its top surface or its bottom surface. If the first surface of the first layer 110 is its bottom surface, then a layer sequence of the strain gage will be reversed accordingly with respect to the layer sequence shown in FIG. 7A.

The first part of the first surface 111 may be a part covered by the flat metallic foil 150. Accordingly, an area of the first part of the first surface 111 may be equal to an area of a surface of the flat metallic foil 150. A shape of the first part of the first surface 111 may be the same as a shape of the surface of the metallic foil 150. For example, as shown in FIG. 2 and FIG. 7B, the metallic foil may have a serpentine shape. Accordingly, the first part of the first surface 111 also may have the same serpentine shape.

The first layer 110 will be described with reference to FIGS. 7A-7C as follows.

As shown in FIGS. 7A-7C, the first layer 110 may be a backing of the strain gage 100. The backing of the strain gage 100 may be used to support the metallic foil 150 laminated onto the backing.

The first layer 110 may be an electrically insulating plastic layer. For example, the first layer 110 may be made from one or multiple resin materials. In an embodiment, the first layer 110 may be made from at least one resin material from a group comprising polyimide, polyester, fiber-reinforced epoxy, polyether ether ketone, etc. Preferably, the first layer 110 may be made from at least one of polyimide, polyester, fiber-reinforced epoxy or polyether ether ketone. The above exemplary resin materials are not intended to be exclusive or be limiting to the present application. The first layer 110 may be made from any one or multiple resin materials which can help to obtain the first layer 110 according to an embodiment of this application.

The first layer 110 may be a glass layer which is electrically insulating. In an embodiment, the first layer 110 may be made from at least one material from a group comprising quartz, zinc oxide, tin oxide, magnesium oxide, carbonate, etc. Preferably, the first layer 110 may be made from at least one of quartz, zinc oxide, tin oxide, magnesium oxide or carbonate. The above exemplary materials for the glass layer are not intended to be exclusive or be limiting to the present application. The first layer 110 may be made from any one or multiple materials which can help to obtain the first layer 110 according to an embodiment of this application.

A thickness of the first layer 110 may be greater than the thickness of the flat metallic foil 150 mentioned above. In an embodiment, the thickness of the first layer 110 has a range greater than or equal to approximately 0.0005 and less than or equal to approximately 0.005 inch. In other words, the thickness of the first layer 110 may be at least 5 times the thickness of the flat metallic foil 150, and may be at most 50 times the metallic foil's thickness.

This thickness range of the first layer 110 may be crucial. On the one hand, the least thickness of the first layer 110 (i.e., at least 5 times the thickness of the flat metallic foil 150) may make it possible to offset an expansion difference in a vertical direction between the first layer 110 and the flat metallic foil 150. On the other hand, the first layer 110 (with a thickness of at most 50 times the thickness of the flat metallic foil 150) may help to transfer the external force f₀ mentioned above to the flat metallic foil 150 timely and accurately, and also help to maintain a relatively small size of the strain gage 100.

A Coefficient of Thermal Expansion (CTE) of the first layer 110 may vary because of different materials used for manufacturing the first layer 110. In an embodiment, a CTE of the first layer 110 may have a range greater than or equal to approximately 10×10⁻⁶/° F. and less than or equal to 70×10⁻⁶/° F.

Preferably, the combined CTE of the metallic foil 150 and the first layer 110 may be close to or the same as that of the test object 200. The closer they are the smaller the magnitude of the stress developed in the glue-line upon a change in environmental temperature. Therefore, the materials of the metallic foil 150 and the first layer 110 may be predetermined by a test object which the strain gage 100 will be attached to. For example, if the strain gage 100 will be attached to a metal substrate (e.g., an aluminum surface of a metal device), then the combined CTE of the metallic foil 150 and the first layer 110 may be predetermined to be approximately 13×10⁻⁶/° F.

It will be noted that typically, there are three types of thermal expansion: linear expansion, volume expansion and area expansion. Here in this application, although as an environmental temperature changes the test object 200 may accordingly change its volume and surface area as well, those volume and surface area changes may be ignored. Further, because the metallic foil 150 is flat and attached to the test object 200 to measure a strain caused by the external force f₀ in a horizontal direction shown in FIG. 3, the measurement will be merely focusing on a linear expansion in the horizontal direction. Therefore, the thermal expansion in this application focuses on a linear expansion. Thus, in the present application, unless otherwise indicated, the terms “thermal expansion” and “linear expansion” are interchangeable. Accordingly, the term “CTE” represents a coefficient of linear expansion.

An elastic modulus of the first layer 110 may vary because of different materials used for manufacturing the first layer 110. In an embodiment, the elastic modulus of the first layer 111 has a range greater than or equal to approximately 0.5×10⁶ pounds per square inch (PSI) and less than or equal to approximately 5×10⁶ PSI.

It will be noted that typically there are three types of elastic modulus: Young's modulus, shear modulus and bulk modulus. This application mainly addresses a resistance of the strain gage 100 to be deformed elastically in a horizontal direction shown in FIG. 3 when an external force is applied to it. Therefore, shear modulus and bulk modulus are not parameters which should be considered for manufacturing the strain gage 100 according to this application. Thus, in this application, unless otherwise indicated, the terms “elastic modulus” and “Young's modulus” are interchangeable.

A third layer 130 in the strain gage 100 will be described with reference to FIGS. 7A-7C as follows.

As shown in FIGS. 7A-7C, the third layer 130 is coated on the flat metallic foil 150 and a second part of the first surface 111 of the first layer 110. The third layer 130 may be used to protect the other components under it.

In one embodiment, the third layer 130 may be a film layer. For example, the third layer 130 may be made from at least one material from a group comprising silicon nitride, silicon oxide, etc. Preferably, the third layer 130 may be made from at least one of silicon nitride or silicon oxide.

In another embodiment, the third layer 130 may be a plastic layer protecting the other components in the strain gage 100. For example, the third layer 130 may be made from a resin material or multiple resin materials. In an embodiment, the third layer 130 may be made from at least one material from a group comprising polyimide, polyester, fiber-reinforced epoxy, polyether ether ketone, etc. Preferably, the third layer 130 may be made from at least one of polyimide, polyester, fiber-reinforced epoxy or polyether ether ketone.

It will be appreciated that the above-mentioned materials for the third layer 130 are not intended to be exclusive or be limiting to the present application. The third layer 130 may be manufactured from any materials as long as those materials are suitable to protect those components under the third layer 130.

When manufacturing the strain gage 100, the third layer 130 will be coated on the first surface 111 of the first layer 110 after the metallic foil 150 has been laminated onto the first surface 111 of the first layer 110. Therefore, the third layer 130 may not cover all area of the first surface 111. That is, the third layer 130 may cover two parts: the flat metallic foil 150 and a second part of the first surface 111 (i.e., an area of the first surface 111 not covered by the flat metallic foil 150).

In one embodiment, the second part of the first surface 111 may cover all area of the first surface 111 not covered by the metallic foil 150 in order to fully protect other components under the third layer 130. In another embodiment, the second part of the first surface 111 may only cover a part of that area of the first surface 111 not covered by the metallic foil 150 so that only a part of those components under the third layer 130 may be protected.

A CTE of the third layer 130 may be greater than or substantially the same as that of the flat metallic foil 150. In that case, when an environmental temperature changes, the third layer 130 may expand either faster than the flat metallic foil 150 or at the same expanding rate as that of the flat metallic foil 150. Thus, the third layer 130 may not be broken by an expansion of the flat metallic foil 150.

The third layer 130 may have a CTE slightly less than that of the flat metallic foil 150. In that case, although the third layer 130 may expand slower than the flat metallic foil 150, the third layer 130 can still protect the flat metallic foil 150 because of an elasticity of the third layer 130.

In an embodiment, a CTE of the third layer 130 may have a range greater than or equal to approximately 5×10⁻⁶/° F. and less than or equal to 70×10⁻⁶/° F.

The second layer 120 in the strain gage 100 will be described with reference to FIGS. 7A-7C as follows.

The second layer 120 may be laminated onto the second surface 112 of the first layer 110. The second surface 112 is opposite to the first surface 111, and a CTE of the second layer 120 may be greater than a threshold value.

As shown in FIG. 7A, the second surface 112 of the first layer 110 is the bottom surface of the first layer 110. However, the relative positions of those surfaces shown in FIG. 7A are not intended to be limiting to the present application. The basic principle is that the first surface 111 and the second surface 112 are opposite to each other. In one embodiment, the first surface of the first layer may be the bottom surface of the first layer, and accordingly the second surface of the first layer may be the top surface of the first layer.

As shown in FIG. 7A, the second layer 120 has two surfaces, i.e., a first surface 121 (i.e., a bottom surface of the second layer 120 shown in FIG. 7A) and a second surface 122 (i.e. a top surface of the second layer 120 shown in FIG. 7A). The first surface 121 of the second layer 120 is opposite to the second surface 122 of the second layer 120. The second surface 122 of the second layer 120 is attached to the second surface 112 of the first layer 110.

The purpose of laminating the second layer 120 is to modify an overall CTE of the strain gage 100 so that the overall CTE of the strain gage 100 may be closer to that of the test object 200. Therefore, as environmental temperature changes the stress developed in the glue-line 300 between the strain gage 100 and the test object 200 may be substantially reduced, and thus strains can be accurately measured by the strain gage 100 before the adhesive layer 300 fails from an over stress condition.

Typically the strain gage 100 will be attached to a metal device to measure a strain. If the metal device has a high thermal expansion coefficient, then the overall CTE of the strain gage 100 needs to be increased to minimize the stress developed in the glue-line 300 upon an increase in the environmental temperature. Although the second layer 120 is located at a relative lower part in the strain gage 100, it may have a desirable thickness and a desirable CTE which could correspondingly modify the overall CTE of the strain gage 100.

In an embodiment, the threshold value may be the CTE of the flat metallic foil 150. That is, the CTE of the second layer 120 may be greater than the CTE of the metallic foil 150. Further, in this embodiment, the CTE of the second layer 120 may be less than or equal to that of the test object 200. Since the CTE of the second layer 120 has a range between the CTE of the metallic foil 150 and the CTE of the test object 200, the second layer 120 may play a transition role between the test object 200 and the strain gage 100 from a linear expansion perspective. That is, the second layer 120 may reduce the stress developed in the glue line upon a change in environmental temperature.

It will be appreciated that in the above embodiment, the overall CTE of the strain gage 100 can be increased if the CTE of the second layer 120 is larger than that of the metallic foil 150. The increased overall CTE of the strain gage 100 may reduce the CTE difference between the strain gage 100 and the test object 200 in order to maintain the CTE difference within the above-mentioned desired range.

The CTE of the second layer 120 may not be significantly smaller than that of the test object 200, because if the CTE of the second layer 120 is significantly smaller than that of the test object 200, then it would be impossible to increase the overall CTE of the strain gage 100 to reach the lower end of the desired range (e.g., approximately −3×10⁻⁶/° F.), thereby causing the CTE difference between the strain gage 100 and the test object 200 to go beyond of the desired range described with reference to FIG. 6.

The CTE of the second layer 120 may not be significantly larger than that of the test object 200, because if the CTE of the second layer 120 is significantly larger than that of the test object 200, then the overall CTE of the strain gage 100 might be much larger than the CTE of the test object 200, thereby causing the CTE difference between the strain gage 100 and the test object 200 to go beyond the desired range (e.g., approximately 3×10⁻⁶/° F.) described with reference to FIG. 5.

In an embodiment, the CTE of the second layer 120 may be greater than or equal to that of the flat metallic foil 150 and less than or equal to that of the test object 200.

The threshold value may be the CTE of the first layer 110. That is, the CTE of the second layer 120 may be greater than CTE of the first layer 110.

Preferably, the threshold value may be 11×10⁻⁶/° F. That is, the CTE of the second layer 120 may be greater than 11×10⁻⁶/° F.

Preferably, the CTE of the second layer 120 may have a range from 11×10⁻⁶/° F. to 15×10⁻⁶/° F.

Preferably, the CTE of the second layer 120 may have a range from 12×10⁻⁶/° F. to 14×10⁻⁶/° F.

Preferably, the CTE of the second layer 120 may be approximately 13×10⁻⁶/° F.

An elastic modulus of the second layer 120 may or may not be equal to that of the flat metallic foil 150. The second layer 120 may also help to maintain a rigidity of the strain gage 100.

In an embodiment, the elastic modulus of the second layer 120 has a range greater than or equal to approximately 5×10⁶ pounds per square inch (PSI) and less than or equal to approximately 40×10⁶ PSI.

Preferably, the elastic modulus of the second layer 120 is approximately 10×10⁶ PSI.

A thickness of the second layer 120 may have a range greater than or equal to approximately 0.001 inch and less than or equal to approximately 0.01 inch. In other words, the thickness of the second layer 120 may be at least 10 to 100 times thicker than the metallic foil 150.

The second layer 120 may be made from the same material as the flat metallic element 150.

For example, in an embodiment, the second layer 120 may be made from one or multiple of nickel alloys. In another embodiment, the second layer 120 may also be made from one or multiple of iron alloys. In a third embodiment, the second layer 120 may also be made from one or multiple of platinum alloys. Further, the second layer 120 may be made from any combination of multiple alloys mentioned above.

The second layer 120 may be made from a material different from the flat metallic element 150. For example, in an embodiment, the second layer may be made from at least one metal from a group comprising aluminum, copper, silver, gold, etc. Preferably, the second layer may be made from at least one of aluminum, copper, silver or gold.

Although the above-mentioned embodiments describe those materials which could be used to manufacture the second layer 120, it will be appreciated that they are only described as a way of example, and they are not intended to be exclusive or be limiting to the present application. The second layer 120 may be manufactured from any materials as long as those materials are suitable to obtain the above-mentioned characteristics of the second layer 120.

As shown in FIGS. 7A-7C, the strain gage 100 may further comprise a fourth layer 140. The fourth layer 140 may also be used to protect those components above it. The fourth layer 140 will be further described as follows.

The fourth layer 140 may be laminated onto the first surface 121 of the second layer 120. As shown in FIGS. 7A-7C, the first surface 121 of the second layer 120 is the bottom surface of the second layer 120.

It will be appreciated that in the above description, the first surface 121 and the second surface 122 represent the bottom surface and the top surface of the second layer 120 respectively, and they are not intended to be limiting to the present application. In embodiments, by laminating the second layer 120 onto the first layer 110 and laminating the fourth layer 140 onto the second layer 120, one surface of the second layer 120 may be attached to the first layer 110, and another surface of the second layer 120 may be attached to the fourth layer 140.

The fourth layer 140 may be an electrically insulating plastic layer. For example, the fourth layer 140 may be made from a resin material or multiple resin materials. In an embodiment, the fourth layer 140 may be made from at least one from a group comprising polyimide, polyester, fiber-reinforced epoxy, polyether ether ketone, etc. Preferably, the fourth layer 140 may be made from at least one of polyimide, polyester, fiber-reinforced epoxy or polyether ether ketone.

The fourth layer 140 may be a glass layer which is electrically insulating. For example, the fourth layer 140 may be made from at least one material from a group comprising quartz, zinc oxide, tin oxide, magnesium oxide, carbonate, etc. Preferably, the fourth layer 140 may be made from at least one of quartz, zinc oxide, tin oxide, magnesium oxide or carbonate.

It will be appreciated that the above-mentioned materials which may be used for manufacturing the fourth layer 140 are only described by way of example, and they are not intended to be exclusive or be limiting to the present application. The fourth layer 140 may be manufactured from any materials as long as those materials are suitable to obtain those characteristics of the fourth layer 140 described in this application.

In one embodiment, a thickness of the fourth layer 140 has a range greater than or equal to 0.0005 and less than or equal to 0.005 inch. In other words, the thickness of the fourth layer 140 may be at least 1/20 times the thickness of the second layer 120, and may be at most 5 times the thickness of the second layer 120.

On the one hand, the fourth layer 140, with at least 1/20 of the thickness of the second layer 120, may have enough strength for supporting and protecting those components above it. On the other hand, the fourth layer 140, with at most 5 times the thickness of the second layer 120, may also help to maintain a relatively small size of the strain gage 100.

In an embodiment, a CTE of the fourth layer 140 may be substantially the same as that of the second layer 120. In that case, when an environmental temperature changes, the fourth layer 140 may expand at substantially the same expanding rate as that of the second layer 120.

In an embodiment, a CTE of the fourth layer 140 may be relatively greater than that of the second layer 120 and relatively less than that of the test object 200. In that case, the fourth layer 140 may also be used to modify the overall CTE of the strain gage 100. In other words, the fourth layer 140 may also play a transition role between the test object 200 and the strain gage 100. Thus, the fourth layer 140 may also help to reduce a glue-line stress difference by obtaining a CTE difference between the strain gage 100 and the test object 200 within the above-mentioned desired range.

A strain gage according to another embodiment of this application will be described as follows. The strain gage according to this embodiment of this application may comprise: a flat metallic element; a first layer, wherein the flat metallic element is laminated onto a first surface of the first layer and the flat metallic element covers a first part of the first surface of the first layer; and a material incorporated into the first layer and used to modify a coefficient of thermal expansion (CTE) of the strain gage to be greater than a threshold value.

In this embodiment, flat metallic element is similar to the flat metallic element 150 shown in FIGS. 7A-7C, and the first layer is similar to the first layer 110 shown in FIGS. 7A-7C. In this embodiment, the strain gage may further comprise a third layer which is similar to the third layer 130 shown in FIGS. 7A-7C, and a second layer which is similar to the second layer 120 shown in FIGS. 7A-7C.

The difference between the strain gage described with this embodiment and the strain gage 100 described with reference to FIGS. 7A-7C is the material incorporated into the first layer. The material may be used to modify the overall CTE of the strain gage to be greater than a threshold value.

Preferably, the material may have a relatively large CTE. When preparing the first layer, the material may be filled or incorporated into the first layer so that a CTE of the first layer may be modified, thereby modifying the overall CTE of the strain gage. The threshold value may be a CTE of the first layer. Preferably, the threshold value may be approximately 11×10⁻⁶/° F.

In an embodiment, the threshold value may have a range similar to or the same as one of those threshold value ranges in the above embodiments mentioned with reference to FIGS. 7A-7C.

For example, the first layer may be a plastic layer made from resin materials. In one embodiment, at least one from a group of metals comprising aluminum, copper, gallium, indium, etc., may be filled into the plastic layer so that a CTE of the first layer may be modified. In another embodiment, at least one from a group of alloys comprising aluminum oxide, zinc oxide, etc., may be filled into the plastic layer. It will be appreciated that the above-mentioned metal materials and alloy materials are not intended to be limiting to the present application. Any material which may be available to modify an overall CTE of the strain gage may be filled or incorporated into it based on the principle of the present application.

Preferably, the material may be used to modify a CTE difference between the strain gage and the test object to be within a desired range (e.g., a range from approximately −3×10⁻⁶/° F. to approximately 3×10⁶/° F. as mentioned above).

Preferably, the material may be incorporated into any one of the first layer and the third layer of the strain gage. In another embodiment, the material may be incorporated into both the first layer and the third layer of the strain gage.

Preferably, the strain gage may further comprise a second layer. The second layer is laminated onto a second surface of the first layer, wherein the second surface of the first layer is opposite to the first surface of the first layer, and a CTE of the second layer is greater than a CTE of the first layer. The above-mentioned material may also be filled or incorporated in the second layer so that a CTE of the second layer may be used to modify the overall CTE of the strain gage to be greater than a threshold value. Preferably, incorporating the material into the second layer may also help to obtain a desired CTE difference between the strain gage and the test object.

It will be appreciated that the material described in the above embodiment may also be used in those embodiments described with reference to FIGS. 1-7C. For example, the material may be filled or incorporated into any one or any combination of the first layer 110, the second layer 120, the third layer 130, and the fourth layer 140 shown in FIGS. 7A-7C for the purpose of modifying the overall CTE of the strain gage 100.

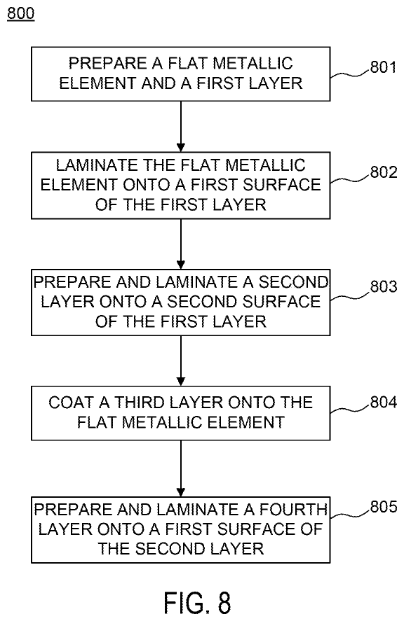

A method for manufacturing a strain gage according to an embodiment of this application will be described with reference to FIG. 8 together with FIGS. 1-3 as follows. FIG. 8 is a flowchart illustrating a method 800 for manufacturing a strain gage according to an embodiment of the present application.

As shown in FIG. 8, the method 800 comprises: at 801, preparing a flat metallic element and a first layer; at 802, laminating the flat metallic element onto a first surface of the first layer wherein the flat metallic element covers a first part of the first surface of the first layer; and at 803, preparing and laminating a second layer onto a second surface of the first layer, wherein the second surface is opposite to the first surface, and a coefficient of thermal expansion (CTE) of the second layer is greater than a threshold value. The method 800 will be described in detail as follows.

It will be noted that the method 800 may be used to manufacture the strain gage 100 shown in FIGS. 7A-7C. Therefore, unless otherwise indicated, those components mentioned with respect to the method 800 below will be corresponding to those components described above with reference to FIGS. 7A-7C.

At 801, in an embodiment, preparing a flat metallic element may comprise obtaining the flat metallic element 150 mentioned. The flat metallic element 150 may be one of flat metallic elements existing in the market which may be used to measure a strain. The flat metallic element prepared at 801 may also be any other known or unknown metallic elements which could be used to measure a strain according to the principles of the present application.

In an embodiment, preparing a flat metallic element may comprise manufacturing the flat metallic element 150. At 801, manufacturing the flat metallic element 150 may comprise any procedure necessary to manufacture a flat metallic element designed for measuring a strain. The present application does not limit those procedures necessary to manufacture a flat metallic element.

At 801, a first layer may also be prepared. In an embodiment, the first layer prepared at 801 may be the first layer 110 mentioned above with reference to FIGS. 7A-7C.

In one embodiment, at 801, the flat metallic element 150 and the first layer 110 may be prepared at the same time. For example, a manufacturer of the strain gage 100 may manufacture the flat metallic element 150 and the first layer 110 at the same time. In another embodiment, the flat metallic element 150 and the first layer 110 may be prepared in a sequence. For example, the flat metallic element 150 may be manufactured first, and then the first layer 110 may be manufactured.

Although the above embodiments describe that the flat metallic element 150 and the first layer 110 may be prepared either at the same time or in a sequence, it will be appreciated that those embodiments are not intended to be exclusive or be limiting to the present application. For example, other components in the strain gage 100 may also be prepared at 801. In an embodiment, a manufacturer may prepare the flat metallic element 150, the first layer 110 and other layers (e.g., the second layer 120) at the same time or in any desirable sequence. Those processes for preparing other layers will be described below with reference to FIG. 8.

At 802, laminating the flat metallic element prepared at 801 onto a first surface of the first layer prepared at 801, wherein the flat metallic element covers a first part of the first surface of the first layer.

The laminating process at 802 may vary depending on types of materials of the flat metallic element and types of materials of a test object onto which the flat metallic element will be laminated. For example, the laminating process at 802 may comprise at least one process from a group comprising heating, pressing, welding, coating, gluing, etc. Preferably, the laminating process at 802 may comprise at least one of heating, pressing, welding, coating or gluing. It will be appreciated that the above-mentioned example of laminating process is not intended to be exclusive and be limiting to the present application. The present application does not limit those processes necessary to the laminating process at 802.

As shown in FIG. 8, at 803, preparing and laminating a second layer onto a second surface of the first layer, wherein the second surface is opposite to the first surface, and a CTE of the second layer is greater than a threshold value.

In one embodiment, the second layer prepared at 803 may be the second layer 120 mentioned above with reference to FIG. 7A. In another embodiment, the second layer prepared at 803 may be any type of metallic layers existing in the market which may be used to modify an overall CTE of the strain gage manufactured by the method 800. The second layer prepared at 803 may also be any other known or unknown layer with a relatively high CTE which could be used to modify an overall CTE of the strain gage.

The laminating process at 803 may vary depending on types of materials of the second layer and types of materials of the first layer onto which the second layer will be laminated. For example, the laminating process at 803 may comprise at least one from a group comprising heating, pressing, welding, coating, gluing, etc. Preferably, the laminating process at 803 may comprise at least one of heating, pressing, welding, coating or gluing. It will be appreciated that the above-mentioned example of a laminating process is not intended to be exclusive and be limiting to the present application. The present application does not limit those processes necessary to the laminating process at 803.

In an embodiment, as shown in FIG. 8, the method 800 may further comprise: at 804, coating a third layer onto the flat metallic element, wherein the third layer covers a second part of the first surface of the first layer prepared at 801.

In one embodiment, the third layer processed at 804 may be the third layer 130 mentioned above with reference to FIG. 7A. In another embodiment, the third layer processed at 804 may be one of film layers existing in the market which may be used to protect other components in the strain gage. The third layer processed at 804 may also be any other known or unknown protection layer which could be used to protect other components in the strain gage.

The coating process may vary depending on types of materials of the third layer and types of materials of the first layer and the flat metallic element onto which the third layer will be coated. For example, the coating process at 804 may comprise at least one process from a group comprising heating, painting, roll-to-roll coating, cooling, etc. Preferably, the coating process at 804 may comprise at least one of heating, painting, roll-to-roll coating or cooling. It will be appreciated that the above-mentioned example of coating process is not intended to be exclusive and be limiting to the present application. The present application does not limit those processes necessary to the coating process at 804.

As shown in FIG. 8, the method 800 may further comprise: at 805, preparing and laminating a fourth layer onto a first surface of the second layer.

In one embodiment, the fourth layer processed at 805 may be the fourth layer 140 mentioned above with reference to FIG. 7A. In another embodiment, the fourth layer processed at 805 may be any plastic layer existing in the market which may be used to support and protect other components in the strain gage. The fourth layer processed at 805 may also be any other known or unknown backing layer which could be used to support and protect other components in the strain gage.

The laminating process at 805 may vary depending on types of materials of the fourth layer and types of materials of the third layer onto which the fourth layer will be laminated. For example, the laminating process at 805 may comprise at least one process from a group comprising heating, pressing, welding, coating, gluing, etc. Preferably, the laminating process at 805 may comprise at least one of heating, pressing, welding, coating or gluing. It will be appreciated that the above-mentioned example of laminating process is not intended to be exclusive and be limiting to the present application. The present application does not limit those processes necessary to the laminating process at 805.

It will be appreciated that the terminology used in the present application is for the purpose of describing particular embodiments and is not intended to limit the application. The singular forms “a”, “the”, and “the” may be intended to comprise a plurality of elements. The terms “including” and “comprising” are intended to include a non-exclusive inclusion. Although the present application is described in detail with reference to the foregoing embodiments, it will be appreciated that those foregoing embodiments may be modified, and such modifications do not deviate from the scope of the present application.

1. A strain gage, comprising:
a flat metallic element;
a first layer, wherein the flat metallic element is laminated onto a first surface of the first layer and the flat metallic element covers a first part of the first surface of the first layer; and
a second layer laminated onto a second surface of the first layer, wherein the second surface is opposite to the first surface, and a coefficient of thermal expansion (CTE) of the second layer is greater than a threshold value, and wherein the second layer consists of one or more metals.

2. The strain gage of claim 1, wherein a CTE difference between the strain gage and an object to which the strain gage is to be attached is no greater than 3×10⁻⁶/° F.

3. The strain gage of claim 1, wherein the threshold value is a CTE of the flat metallic element.

4. The strain gage of claim 1, wherein the threshold value is a CTE of the first layer.

5. The strain gage of claim 1, wherein the CTE of the second layer has a range from 11×10⁻⁶/° F. to 15×10⁻⁶/° F.

6. The strain gage of claim 1, wherein a thickness of the second layer has a range greater than or equal to 0.001 inch and less than or equal to 0.01 inch.

7. The strain gage of claim 1, wherein the one or metals of the second layer includes at least one of aluminum, copper, silver and gold.

8. The strain gage of claim 1 further comprising a third layer coated on the flat metallic element, wherein the third layer covers a second part of the first surface of the first layer.

9. The strain gage of claim 1 further comprising a fourth layer laminated onto the second layer opposite the first layer.

10. A method for manufacturing a strain gage, comprising:
preparing a flat metallic element and a first layer;
laminating the flat metallic element onto a first surface of the first layer wherein the flat metallic element covers a first part of the first surface of the first layer; and
preparing and laminating a second layer onto a second surface of the first layer, wherein the second surface is opposite to the first surface, and a coefficient of thermal expansion (CTE) of the second layer is greater than a threshold value, and wherein the second layer consists of one or more metals.

11. The method of claim 10, wherein a CTE difference between the strain gage and an object to which the strain gage is to be attached is no greater than 3×10⁻⁶/° F.

12. The method of claim 10, wherein the threshold value is a CTE of the flat metallic element.

13. The method of claim 10, wherein the threshold value is a CTE of the first layer.

14. The method of claim 10, wherein the CTE of the second layer has a range from 11×10⁻⁶/° F. to 15×10⁻⁶/° F.

15. The method of claim 10, wherein a thickness of the second layer has a range greater than or equal to 0.001 inch and less than or equal to 0.01 inch.

16. The method of claim 10, wherein the one or metals of the second layer includes at least one of aluminum, copper, silver and gold.

17. The method of claim 10 further comprising: coating a third layer on the flat metallic element, wherein the third layer covers a second part of the first surface of the first layer.

18. The method of claim 10 further comprising:
preparing and laminating a fourth layer onto the second layer opposite the first layer.

19-20. (canceled)

21. The strain gauge according to claim 1, wherein the flat metallic element and the second layer are made of the same metal or metals.

22. The strain gauge according to claim 1, wherein the one or more metals of the second layer is at least one of a nickel alloy, an iron alloy, or a platinum alloy.
